(19) United States
(12) Patent Application Publication
(10) Pub. No.: US 2023/0252344 A1
(43) Pub. Date: Aug. 10, 2023

(54) MACHINE LEARNING APPARATUS, MACHINE LEARNING METHOD, AND INFERENCE APPARATUS

(71) Applicant: KABUSHIKI KAISHA TOSHIBA, Tokyo (JP)

(72) Inventors: Nao MISHIMA, Inagi (JP); Quoc Viet PHAM, Yokohama (JP); Yusuke HOSOYA, Fuchu (JP); Hiroshi FUJIMURA, Yokohama (JP)

(73) Assignee: KABUSHIKI KAISHA TOSHIBA, Tokyo (JP)

(21) Appl. No.: 17/822,553

(22) Filed: Aug. 26, 2022

(30) Foreign Application Priority Data
Feb. 10, 2022 (JP) 2022-019858

(51) Int. Cl. G06N 20/00; G06N 5/04

(52) U.S. Cl. CPC G06N 20/00; G06N 5/04

(57) ABSTRACT

According to one embodiment, a machine learning apparatus includes a processing circuit. The processing circuit generates a training sample in a VQA format regarding a VQA task based on a sample in a non-VQA format. The training sample in the VQA format includes a combination of an object, a question text regarding the object and an answer text in response to the question text as elements, and the sample in the non-VQA format includes a combination of an object and a label related to the object as elements. The processing circuit trains a statistical model of the VQA task based on the generated training sample in the VQA format.

### CROSS-REFERENCE TO RELATED APPLICATIONS

This application is based upon and claims the benefit of priority from Japanese Patent Application No. 2022-019858, filed Feb. 10, 2022, the entire contents of which are incorporated herein by reference.

### FIELD

Embodiments described herein relate generally to a machine learning apparatus, a machine learning method, and an inference apparatus.

### BACKGROUND

In a field of machine learning, a task that receives input of an image and a question in a text format regarding the image and outputs an answer in a text format in response to the question is known. The task is referred to as visual question answering (VQA). A statistical model of the VQA task is trained based on a training data set provided as a combination (taple) of an image, a question and an answer. There can be enormous variations in the combination of the image and the question regarding the image, and thus, the variations are secured by preparing hundreds of thousands of questions with respect to several tens of thousands of images in a training data set of VQA called VQAv2. For example, if it is tried to generate a statistical model that can support specific animals and plants or vehicles, it is necessary to prepare images regarding the specific objects and all kinds of variations of questions and answers regarding the images. Preparation of a training data set including a wide variety of combinations of images, questions and answers involves an enormous cost. Even if a statistical model is trained with a training data set with less variations in order to reduce cost, a statistical model with high accuracy cannot be generated. Efficient learning that can generate a statistical model with high accuracy at low cost is desired.

### BRIEF DESCRIPTION OF THE DRAWINGS

FIG. 1 is a view illustrating a configuration example of a machine learning apparatus according to the present embodiment.

FIG. 2 is a view illustrating processing procedure of machine learning processing by the machine learning apparatus.

FIG. 3 is a view schematically illustrating the machine learning processing illustrated in FIG. 2.

FIG. 4 is a view illustrating a network configuration example of a statistical model.

FIG. 5 is a view schematically illustrating machine learning processing according to a first embodiment.

FIG. 6 is a view schematically illustrating machine learning processing according to a comparative example.

FIG. 7 is a view illustrating an example of a prediction result of a statistical model trained through machine learning according to the first embodiment.

FIG. 8 is a view illustrating an example of a prediction result of a statistical model trained through machine learning according to the comparative example regarding the first embodiment.

FIG. 9 is a view schematically illustrating machine learning processing according to a second embodiment.

FIG. 10 is a view schematically illustrating machine learning processing according to a third embodiment.

FIG. 11 is a view illustrating an example of a prediction result of a statistical model trained through machine learning according to the third embodiment.

FIG. 12 is a view illustrating an example of a prediction result of a statistical model trained through machine learning according to the comparative example regarding the third embodiment.

FIG. 13 is a view schematically illustrating machine learning processing according to a fourth embodiment.

FIG. 14 is a view illustrating a network configuration example of a statistical model in a case where a modality of an object is a video.

FIG. 15 is a view illustrating a network configuration example of a statistical model in a case where a modality of an object is audio.

FIG. 16 is a view illustrating a network configuration example of a statistical model in a case where a modality of an object is a three-dimensional point cloud.

FIG. 17 is a view illustrating a configuration example of an inference apparatus according to the present embodiment.

FIG. 18 is a view illustrating processing procedure of inference processing by the inference apparatus.

### DETAILED DESCRIPTION

A machine learning apparatus according to embodiments includes a conversion unit and a training unit. The conversion unit generates a training sample in a VQA format regarding a VQA task based on a sample in a non-VQA format. The training sample in the VQA format includes a combination of an object, a question text regarding the object and an answer text in response to the question text as elements, and the sample in the non-VQA format includes a combination of an object and a label related to the object as elements. The training unit trains a statistical model of the VQA task based on the training sample in the VQA format generated by the conversion unit.

A machine learning apparatus, a machine learning method and an inference apparatus according to the present embodiment will be described below with reference to the drawings.

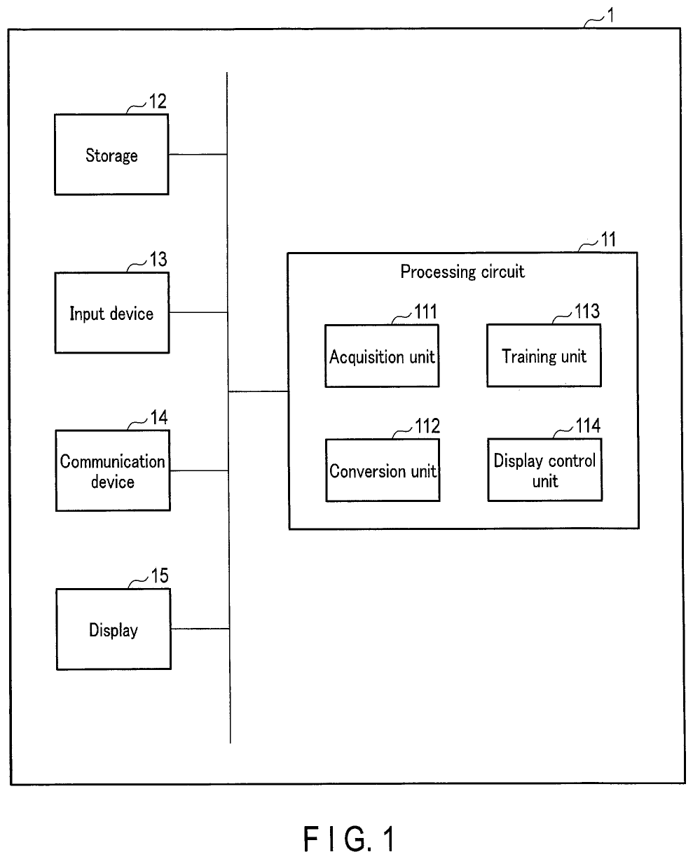

FIG. 1 is a view illustrating a configuration example of a machine learning apparatus 1 according to the present embodiment. As illustrated in FIG. 1, the machine learning apparatus 1 is a computer including a processing circuit 11, a storage 12, an input device 13, a communication device 14 and a display 15. The processing circuit 11, the storage 12, the input device 13, the communication device 14 and the display 15 perform data communication with each other via a bus.

The processing circuit 11 includes a processor such as a central processing unit (CPU) and a memory such as a random access memory (RAM). The processing circuit 11 includes an acquisition unit 111, a conversion unit 112, a training unit 113 and a display control unit 114. The processing circuit 11 implements respective functions of the above-described units 111 to 114 by executing a machine learning program. The machine learning program is stored in a non-transitory computer readable recording medium such as the storage 12. The machine learning program may be implemented as a single program that describes all the functions of the above-described units 111 to 114 or may be implemented as a plurality of modules divided into some functional units. Further, the above-described units 111 to 114 may be implemented by an integrated circuit such as an application specific integrated circuit (ASIC) and a field programmable gate array (FPGA). In this case, the above-described units 111 to 114 may be implemented in a single integrated circuit or may be individually implemented in a plurality of integrated circuits.

The acquisition unit 111 acquires a training sample in a VQA format regarding a VQA task and a data sample in a non-VQA format to train a statistical model of the VQA task. The training sample of the VQA task has a format as a sample to be used to train the statistical model of the VQA task. Specifically, the training sample of the VQA task includes a combination (taple) of an object, a question text regarding the object and an answer text in response to the question as elements. The object means data to be processed. As the object, specifically, an image or a video is used. Note that as the object according to the present embodiment, data obtained by various modalities, such as audio, an output from sensor and/or a three-dimensional point cloud may be used in addition to an image or a video. The training sample in the VQA format is acquired from a database in which a large number of training samples in the VQA format are accumulated. The non-VQA format means a format different from the VQA format. The data sample in the non-VQA format includes a combination of an object and a label related to the object as elements. The label is text data related to semantic content of the object. The data sample in the non-VQA format may be a training sample of a task (non-VQA task) different from the VQA task or does not have to be a training sample. The data sample in the non-VQA format is acquired from a database in which a large number of data samples in the non-VQA format are accumulated.

The conversion unit 112 generates a training sample in the VQA format regarding the VQA task based on the data sample in the non-VQA format. The training sample generated by the conversion unit 112 is also used to train the statistical model of the VQA task. Hereinafter, the training sample in the VQA format acquired from the database of the VQA samples by the acquisition unit 111 will be referred to as a VQA sample, and the training sample generated by the conversion unit 112 will be referred to as an additional sample. Further, the data sample in the non-VQA format acquired by the acquisition unit 111 will be referred to as a non-VQA sample. Still further, in a case where the VQA sample, the non-VQA sample and the additional sample are not distinguished from each other, they will be simply referred to as a sample.

The training unit 113 trains the statistical model of the VQA task based on the additional sample generated by the conversion unit 112. Note that the training unit 113 may train the statistical model of the VQA task based on the additional sample generated by the conversion unit 112 and the VQA sample acquired by the acquisition unit 111.

The display control unit 114 displays various kinds of information on the display 15. For example, the display control unit 114 displays the VQA sample, the additional sample, a prediction result of the VQA task by the statistical model, and the like.

The storage 12 is constituted with a read only memory (ROM), a hard disk drive (HDD), a solid state drive (SSD), an integrated circuit storage device, or the like. The storage 12 stores the machine learning processing program, and the like.

The input device 13 receives input of various kinds of commands from an operator. As the input device 13, a keyboard, a mouse, various kinds of switches, a touch pad, a touch panel display, and the like, can be utilized. An output signal from the input device 13 is supplied to the processing circuit 11. Note that as the input device 13, an input device of a computer connected to the processing circuit 11 in a wired or wireless manner may be used.

The communication device 14 is an interface for performing data communication with an external device connected to the machine learning apparatus 1 via a network. Examples of the external device can include a database of VQA samples, a database of samples in the non-VQA format, and the like.

The display 15 displays various kinds of information under control by the display control unit 114. As the display 15, a cathode-ray tube (CRT) display, a liquid crystal display, an organic electro luminescence (EL) display, a light-emitting diode (LED) display, a plasma display or any other display known in the technical field can be utilized as appropriate. Further, the display 15 may be a projector.

The machine learning apparatus 1 will be described in detail below. It is assumed in the following description that the non-VQA sample is a training sample in a format regarding a non-VQA task. The non-VQA task refers to a task different from the VQA task. The non-VQA task is a task that recognizes, understands and infers a relationship between an object and a label related to the object. As the non-VQA task, an image classification task, an object detection task, a visual grounding task, or an image retrieval task can be applied as an example. It is assumed in the following description that the object is an image.

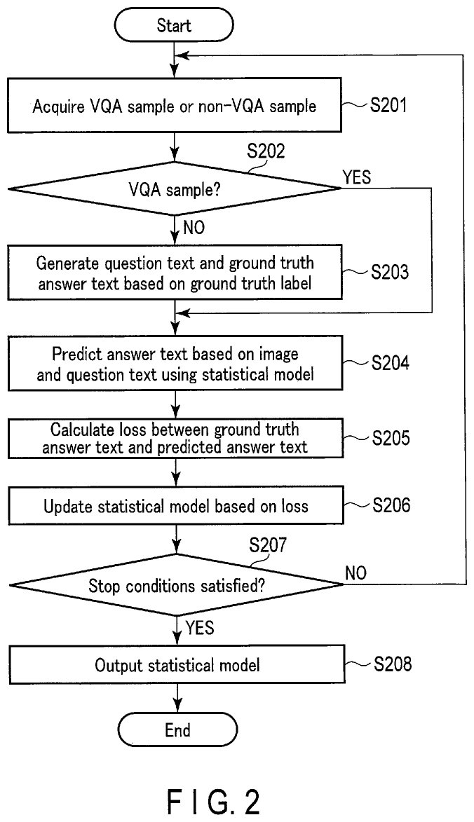

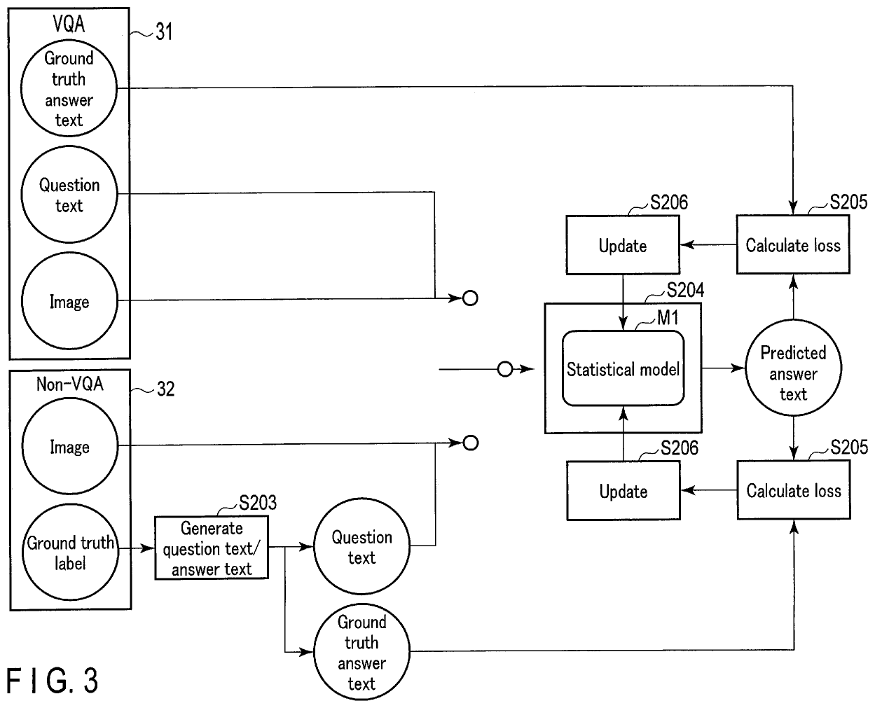

FIG. 2 is a view illustrating processing procedure of machine learning processing by the machine learning apparatus 1. FIG. 3 is a view schematically illustrating the machine learning processing illustrated in FIG. 2. As illustrated in FIG. 2 and FIG. 3, the acquisition unit 111 acquires a VQA sample 31 or a non-VQA sample 32 to train a statistical model of a VQA task (step S201). As an example, the acquisition unit 111 acquires a data set of VQA samples and a data set of non-VQA samples from the storage 12 or an external database and selects samples corresponding to one mini batch from the data set of the VQA samples and the data set of the non-VQA samples. One mini batch according to the present embodiment may include a mixture of VQA samples and non-VQA samples or may include only one of the VQA samples and the non-VQA samples.

The VQA sample 31 includes a combination of an image, a question text with respect to content of the image, and a ground truth answer text in response to the question text. The non-VQA sample 32 includes a combination of an image and a ground truth label with respect to the image. The non-VQA sample 32 includes neither a question text nor a ground truth answer text. For example, in a case where the non-VQA task is an image classification task, an image classification sample is used as the non-VQA sample 32. The image classification sample includes an image and a ground truth label with respect to the image as elements. The ground truth label means a class label of an object in the image. As another example, in a case where the non-VQA task is an object detection task, an object detection sample is used as the non-VQA sample 32. The object detection sample includes an image and a ground truth label with respect to the image as elements. The ground truth label includes a class label of an object in the image and a rectangular (bounding box) parameter surrounding the object.

If the processing in step S201 is performed, the training unit 113 determines whether or not the sample acquired in step S201 is a VQA sample (step S202). In a case where the sample is non-randomly acquired, the processing in step S202 does not have to be executed. In a case where the sample is randomly acquired, the training unit 113 determines that the VQA sample 31 is acquired in a case where the acquired sample includes a question text and a ground truth answer text and determines that the VQA sample 31 is not acquired, that is, the non-VQA sample 32 is acquired in a case where the sample does not include a question text and a ground truth answer text.

Alternatively, in a case where an identifier representing a type of the sample is associated with each sample, the training unit 113 may determine whether or not the sample is the VQA sample based on the identifier.

In a case where it is determined in step S202 that the VQA sample 31 is not acquired, that is, the non-VQA sample 32 is acquired (step S202: No), the conversion unit 112 generates a question text and a ground truth answer text based on the ground truth label of the non-VQA sample 32 (step S203). Processing of generating the question text and the ground truth answer text will be described in detail later.

In a case where the processing in step S203 is performed or in a case where it is determined in step S202 that the VQA sample 31 is acquired (step S202: Yes), the training unit 113 predicts an answer text based on the image and the question text using a statistical model M1 of the VQA model (step S204).

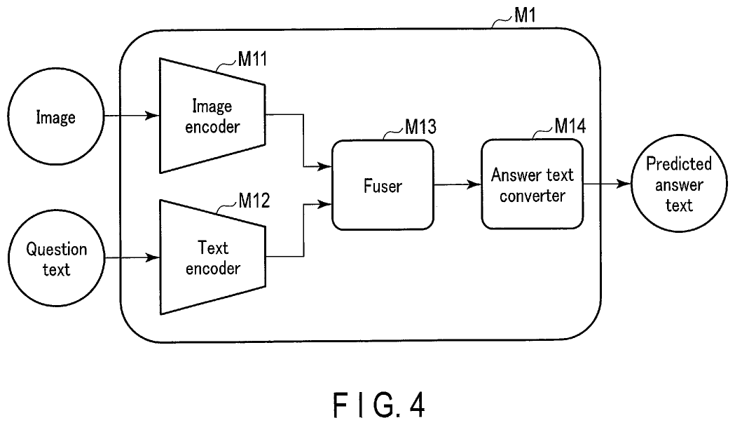

FIG. 4 is a view illustrating a network configuration example of the statistical model M1. As illustrated in FIG. 4, the statistical model M1 is a neural network trained to receive input of an image and a question text and output an answer text. The statistical model M1 includes an image encoder M11, a text encoder M12, a fuser M13 and an answer text converter M14. The image encoder M11 is an encoding network layer that outputs a feature (hereinafter, an image feature) of the input image as image data. The text encoder M12 is an encoding network layer that outputs a feature (hereinafter, a text feature) of the input question text as text data. More specifically, the text encoder M12 converts a question text into a series of word IDs by dividing the question text into a series of words by a tokenizer and uniquely allocating word IDs for each word. The word ID is an identifier uniquely allocated in advance for each word. Then, the text encoder M12 encodes the series of word IDs to convert the series of word IDs into a text feature. The fuser M13 outputs a fused feature obtained by fusing the image feature output from the image encoder M11 and the text feature output from the text encoder M12. The fused feature corresponds to a vector expression of a predicted answer text. The fuser M13 may be a module that performs addition calculation or concatenation or may be an encoding network layer.

The answer text converter M14 is a decoding network layer called a character string decoder (sequence decoder) that converts the fused feature output from the fuser M13 into a character string of natural language representing an answer text. Specifically, the answer text converter M14 converts the fused feature into a plurality of answer word vectors respectively corresponding to a plurality of words constituting the predicted answer text. The answer text converter M14 converts each answer word vector into a series of relative values (logits) representing an occurrence probability of each word. The logit series corresponds to the predicted answer text. The answer word vector is a multidimensional vector having dimensions corresponding to the number of words (hereinafter, registered words) registered in a tokenizer dictionary, and a logit of each registered word for a target word is allocated to each element. While the number of registered words is not particularly limited, for example, there are approximately several tens of thousands to several hundreds of thousands of registered words. Note that the predicted answer text may be a numeric string or a code string instead of a character string. The tokenizer dictionary does not depend on types of samples such as the VQA sample and the image classification sample and is common to all types. Note that in a learning stage, the logit series does not have to be converted into a language sequence representing the predicted answer text. Note that upon inference, the answer text converter M14 generates a character string representing the inferred answer text by converting each of a plurality of logit series into a word with reference to the tokenizer dictionary.

The image encoder M11, the text encoder M12, the fuser M13 and the answer text converter M14 are typically constituted with a multilayer neural network. However, the present embodiment is not limited to this, and a random forest, a recursive partitioning and regression tree (such as a CART), bugging, boosting, support vector machine, or the like, may be used.

If the processing in step S204 is performed, the training unit 113 calculates a loss between the ground truth answer text and the predicted answer text (step S205). Calculation of the loss is performed for the purpose of feeding back the loss between the predicted answer text and the ground truth answer text to the statistical model M1 to reduce an error of the statistical model M1 with respect to the training sample. As the loss according to the present embodiment, cross entropy to be used in a field of language modeling is used.

Specifically, first, the training unit 113 converts the ground truth answer text into a one-hot vector having a value “1” only for a ground truth word ID and having a value “0” for others and performs softmax calculation on the respective logits constituting the predicted answer text to calculate a softmax calculated value. The training unit 113 calculates cross entropy representing a difference between the predicted answer text and the ground truth answer text based on the softmax calculated value of the predicted answer text and the one-hot vector of the ground truth answer text.

If the processing in step S205 is performed, the training unit 113 updates the statistical model M1 based on the loss (step S206). Specifically, the training unit 113 updates learning parameters of the statistical model M1 using an arbitrary optimization method such as a back propagation method. The learning parameters mean parameters to be updated through machine learning among various kinds of parameters set in the statistical model M1 such as a weight parameter and a bias. Calculation of the loss (step S205) and updating of the statistical model M1 (step S206) are typically performed in mini batch unit. However, calculation and updating are not limited to this, and the statistical model M1 may be updated for each of one or a plurality of samples that constitute a batch. Note that while in FIG. 2 and FIG. 3, calculation of the loss (step S205) and updating of the statistical model M1 (step S206) are illustrated as individual processes, in actual processing, both processes are not clearly distinguished from each other.

If the processing in step S206 is performed, the training unit 113 determines whether or not stopping conditions are satisfied (step S207). The stopping conditions can be set to arbitrary conditions such as a condition that the number of iterations from step S201 to step S207 reaches a predetermined number of times or a loss reaches a threshold and a condition that a performance index value reaches a threshold. In a case where it is determined that the stopping conditions are not satisfied (step S207: No), the processing from step S201 to step S207 is repeated for other samples. Then, in a case where it is determined that the stopping conditions are satisfied (step S207: Yes), the training unit 113 outputs the statistical model in which learning parameters in a current number of times of updating are set, as a trained model (step S208). The trained model is stored in the storage 12 or transferred to other computers via the communication device 14, or the like.

As described above, the machine learning processing by the machine learning apparatus 1 ends.

Note that procedure of the processing illustrated in FIG. 2 is an example, and the procedure is not limited to the procedure illustrated in FIG. 2. For example, the statistical model does not have to be trained using both the VQA sample and the non-VQA sample, and the statistical model may be trained only with the non-VQA sample. In this case, the batch is constituted with only the non-VQA samples.

As described above, according to the machine learning processing according to the present embodiment, the non-VQA sample is converted into the additional sample that is a sample in a VQA format, and the statistical model M1 of the VQA task is trained based on the additional sample. By converting the non-VQA sample into additional sample in the VQA format, training samples of the statistical model M1 can be increased. The statistical model M1 can be trained with a variety of training samples, so that it is possible to improve accuracy of the statistical model M1. Further, question texts and answer texts can be automatically generated from ground truth labels of non-VQA samples, so that it is possible to easily increase the number of training samples of the statistical model M1.

The machine learning processing according to the present embodiment will be specifically described below using some examples according to the present embodiment. Note that overall processing procedure of the machine learning processing according to each embodiment described below is as indicated in FIG. 2 and FIG. 3. In the following embodiments, differences between the embodiments will be mainly described.

### First Embodiment

In a first embodiment, machine learning of a statistical model M1 of a VQA task utilizing a VQA sample and an image classification sample will be described. The image classification sample is one example of a non-VQA sample.

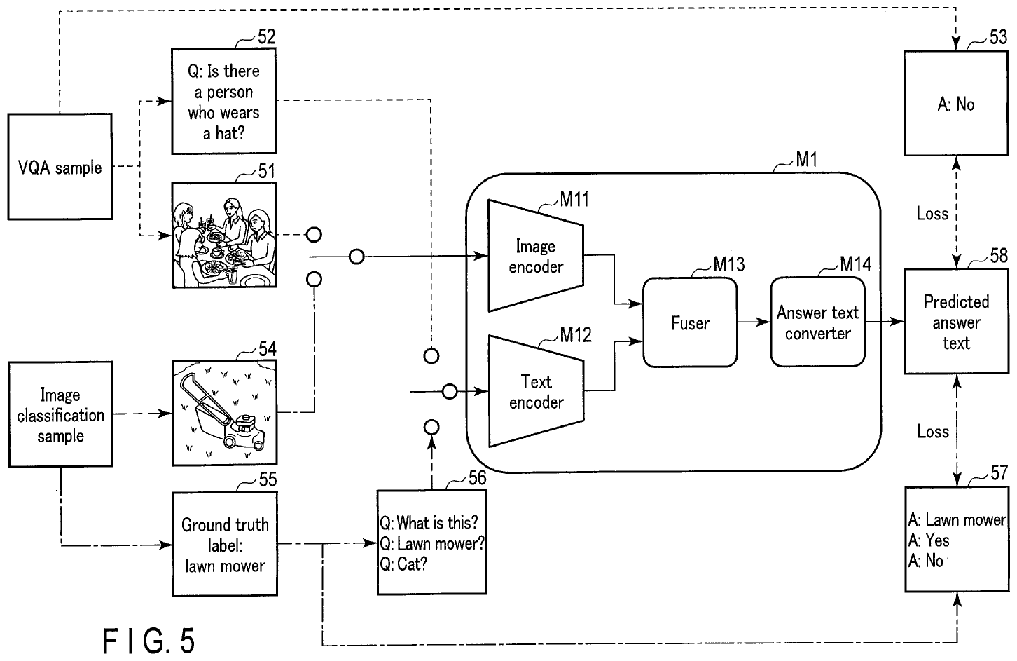

FIG. 5 is a view schematically illustrating machine learning processing to be performed for the statistical model M1 of the VQA task using the VQA sample and the image classification sample according to the first embodiment. As illustrated in FIG. 5, the VQA sample includes a combination of an image 51, a question text 52 and a ground truth answer text 53. In the example in FIG. 5, the image 51 is an image of an aspect in which four women have a meal in a room, the question text 52 is a character string of “Is there a person who wears a hat?”, and the ground truth answer text 53 is a character string of “No”. The image classification sample includes a combination of an image 54 and a ground truth label 55. The ground truth label 55 according to the image classification task is name (class) of an object in the image 54. In the example in FIG. 5, the image 54 is an image of a lawn mower, and the ground truth label 55 is a character string of “lawn mower”. As described above, a loss according to the first embodiment is calculated based on the ground truth answer texts 53 and 57 that are character strings and a predicted answer text 58.

As illustrated in FIG. 5, a question text 56 and a ground truth answer text 57 are generated by a conversion unit 112 based on the ground truth label 55. The question text 56 and the ground truth answer text 57 constitute an additional sample. The combination of the question text 56 and the ground truth answer text 57 regarding the image classification task is classified into the following three types. Note that a character string representing a ground truth label is inserted into a “ground truth label”, and a character string other than a ground truth label is inserted into “other than ground truth label”.

Type 1: Question text “What is this?”, ground truth answer text “‘ground truth label’”
Type 2: Question text “Is this ‘ground truth label’?”, ground truth answer text “Yes”
Type 3: Question text “Is this ‘other than ground truth label’?”, ground truth answer text “No”

As can be seen in Type 1 to Type 3, the question text 56 and the ground truth answer text 57 can be defined in accordance with simple rules based on the ground truth label. By using a template of each of Type 1 to Type 3, the question text 56 and the ground truth answer text 57 can be automatically generated. As illustrated in the example in FIG. 5, in a case where the ground truth label 55 is “lawn mower”, the question text 56 of “What is this?” and the ground truth answer text 57 of “lawn mower” are generated for Type 1, the question text 56 of “Is this a lawn mower?” and the ground truth answer text 57 of “Yes” are generated for Type 2, and the question text 56 of “Is this a cat?” and the ground truth answer text 57 of “No” are generated for Type 3. While a cat is exemplified as a class other than a lawn mower for Type 3, the class is not limited to a cat and can be replaced with name of various objects other than a lawn mower.

According to the question text 56 and the ground truth answer text 57 of Type 1, it is possible to cause the text encoder M12 to learn the ground truth label 55 in association with features of the image. According to the question text 56 and the ground truth answer text 57 of Type 2, it is possible to cause the image encoder M11 and the text encoder M12 to learn a relationship between the ground truth label 55 and the features of the image. If there is only Type 2, there is only a positive sample, which causes bias in learning. The question text 56 and the ground truth answer text 57 of Type 3 are useful as a negative sample.

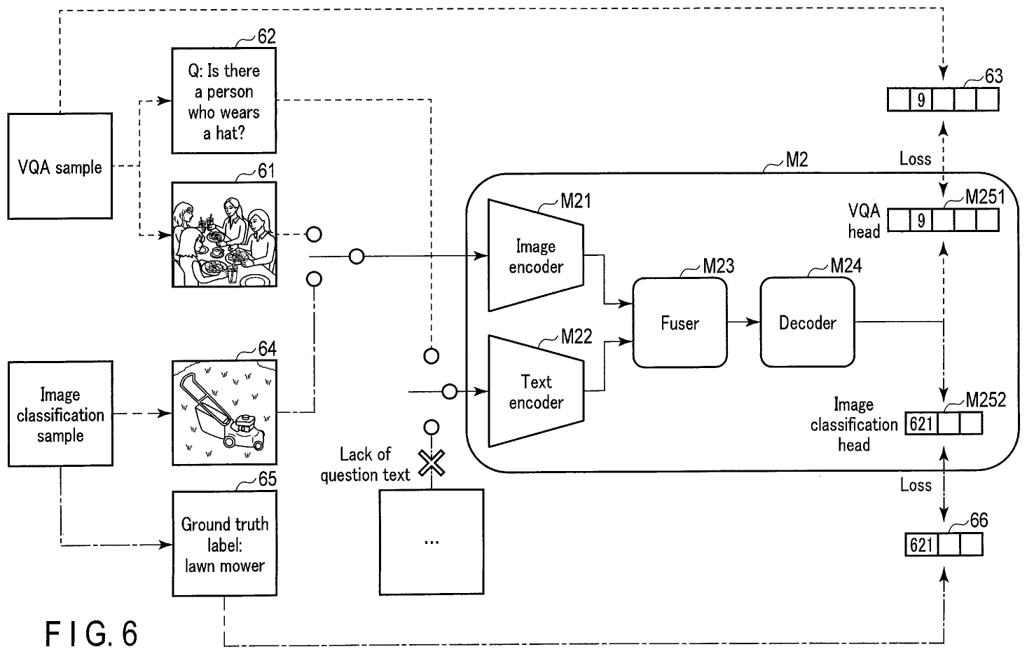

FIG. 6 is a view schematically illustrating machine learning processing of a statistical model using a VQA sample and an image classification sample according to a comparative example. The comparative example is an example in which a technique described in Non-patent Literature 1 (Ronghang Hu, Amanpreet Singh, “UniT: Multimodal Multitask Learning With a Unified Transformer”, Proceedings of the IEEE/CVF International Conference on Computer Vision (ICCV), 2021, pp. 1439-1449) is used. The VQA sample includes a combination of an image 61, a question text 62 and a ground truth answer text 63. The image classification sample includes a combination of an image 64 and a ground truth label 65. The VQA sample and the image classification sample according to the comparative example are substantially the same as the VQA sample and the image classification sample according to the first embodiment. The statistical model M2 of the VQA task according to the comparative example includes an image encoder M21, a text encoder M22, a fuser M23 and a decoder M24. The image encoder M21, the text encoder M22 and the fuser M23 are respectively the same as the image encoder M11, the text encoder M12 and the fuser M13 according to the first embodiment illustrated in FIG. 5.

The decoder M24 decodes a fused feature output from the fuser M23. Heads (output branches) M251 and M252 specific to a type of the task are connected to an output end of the decoder M24. The output branches M251 and M252 are network layers including one or more fully connected layers and/or convolutional layers. In a case where the VQA task is executed, the VQA head M251 is connected, and in a case where the image classification task is executed, the image classification head M252 is connected.

The VQA head M251 outputs a predicted answer based on the decoded fused feature. More specifically, the VQA head M251 converts the decoded fused feature into a predicted answer vector. The predicted answer vector is a multidimensional vector having dimensions corresponding to the number of answer candidate IDs registered in a dictionary, and a relative value (logit) of each answer candidate ID with respect to the predicted answer is allocated to each element. The VQA head M251 specifies an answer candidate ID of a maximum logit, converts the specified answer candidate ID into a character string of the answer candidate using the dictionary and outputs the character string as a predicted answer. In the dictionary, character strings of answer candidates and answer candidate IDs are registered in association with each other. For example, in a case where there are 3000 answer candidates, answer candidate IDs of No. 0 to No. 2999 exist. The loss is calculated based on a difference between the answer candidate ID that is an output of the VQA head M251 and an answer candidate ID corresponding to the ground truth answer text 63.

The image classification head M252 also outputs the predicted class based on the decoded fused feature through processing similar to that of the VQA head M251. A class candidate with the highest likelihood among a plurality of class candidates determined in advance is output as the predicted class. The class candidates are also associated with class IDs in a similar manner to the answer candidates, and association between classes and class IDs is registered in the dictionary. The loss is calculated based on a difference between the class candidate ID that is an output of the VQA head M252 and an answer candidate ID corresponding to the ground truth class 66.

In a case where the statistical model M2 is trained by utilizing the VQA sample, the VQA sample includes an image and a question text, and thus, a relationship between an image feature and a text feature of both is trained. In a case where the statistical model M2 is trained by utilizing the image classification sample, the image classification sample does not include input of text, and thus, nothing is input to the text encoder M12, and only features of the image are trained as a result. In a case where learning of the VQA task is performed, the VQA head M251 is connected to the decoder M24, and the statistical model M2 is trained. The loss is calculated based on the answer candidate ID corresponding to the ground truth answer and the answer candidate ID corresponding to the predicted answer. Thus, the ground truth label as a text included in the image classification sample is not utilized in learning of the VQA task. For example, in a case where the statistical model M2 is trained based on the image classification sample regarding a lawn mower, it is impossible to cause the VQA head M251 to learn a lawn mower as a text. Thus, even if an image of a lawn mower and a question text of “What is this?” are input to the trained statistical model M2 in an inference stage, the statistical model M2 cannot output a predicted answer text of “lawn mower”. Further, even if an image of a lawn mower and a question text of “How many lawn mowers?” are input to the trained statistical model M2, the text encoder M22 has not trained a text feature of a lawn mower, and thus, the statistical model M2 cannot give a good answer.

In the comparative example, learning of the VQA task using the VQA sample and learning of the image classification task using the image classification sample are independently performed by switching the head between the head M251 and the head M252. Thus, association between IDs and candidates in the dictionary is different in accordance with a domain of the sample such as the VQA sample and the image classification sample. For example, there can be a case where while in the statistical model M2 of the VQA task, an ID of “apple” is “159”, in the statistical model M2 of the image classification task, an ID of “apple” is “1035”. Further, the number of types of images included in various kinds of samples is different, and thus, it can be assumed that the number of answer candidates may differ in accordance with types of the head M251 and the head M252. It is difficult to share different kinds of tasks at the head due to these factors.

Further, in the comparative example, the head is switched between the head M251 and the head M252 in accordance with the type of the task, and the head M251 or the head M252 of the classification task that outputs an answer with the highest likelihood among a plurality of candidates is used. Thus, a word not included in the training sample cannot be answered. Further, input/output to the statistical model M2 and the head are different for each task, and thus, a training sample of only a single task can be included in one mini batch. The task is replaced for each iteration of the processing in step S201 to the processing in step S207 in FIG. 2, which increases a possibility that a gradient does not become an optimum when a batch size is large.

Concerning this point, as illustrated in FIG. 5, and the like, the statistical model M1 according to the present embodiment does not use the heads M251 and M252 and includes the answer text converter M14 that outputs a character string instead. In accordance with this, the predicted answer text is output using a tokenizer dictionary common to different types of tasks. This can make an output format of the predicted answer text uniform between the VQA sample and the image classification sample (additional sample). By making the output format uniform, it is possible to train one statistical model M1 with a mixture of the VQA sample and the image classification sample in the same mini batch and using the VQA sample and the image classification sample without distinction. This can reduce a possibility that a gradient does not become an optimum even if the batch size is large. In association with this, the statistical model M1 can be trained by utilizing an image classification sample regarding content that does not exist in the VQA sample, so that it is possible to cause the statistical model M1 to learn new vocabularies compared to a case where training is performed only using the VQA sample.

Further, in the comparative example, it is necessary to use the head M251 and the head M252 specific for each task. In other words, in a case where multitask learning is performed, it is necessary to switch the head between the head M251 and the head M252 for each task. Thus, if multitask learning of the VQA task and the image classification task is performed, it is necessary to perform prediction processing of the statistical model corresponding to two times of prediction processing of the statistical model with the VQA head M251 using the VQA sample and prediction processing of the statistical model with the image classification head M252 using the image classification sample. In contrast, according to the method according to the present embodiment, the image classification sample is converted into the additional sample having the VQA format, and common prediction processing of the statistical model is performed using the additional sample and the VQA sample, so that it is only necessary to perform prediction processing corresponding to one time. While the question text and the ground truth answer text are generated by utilizing the ground truth label included in the image classification sample, as indicated in Type 1 to Type 3 described above, the question text and the ground truth answer text relate to content of the ground truth label of the image classification task. By performing machine learning processing of the statistical model using the additional sample, it is possible to train the statistical model that can substantially perform the image classification task in a format of the VQA task.

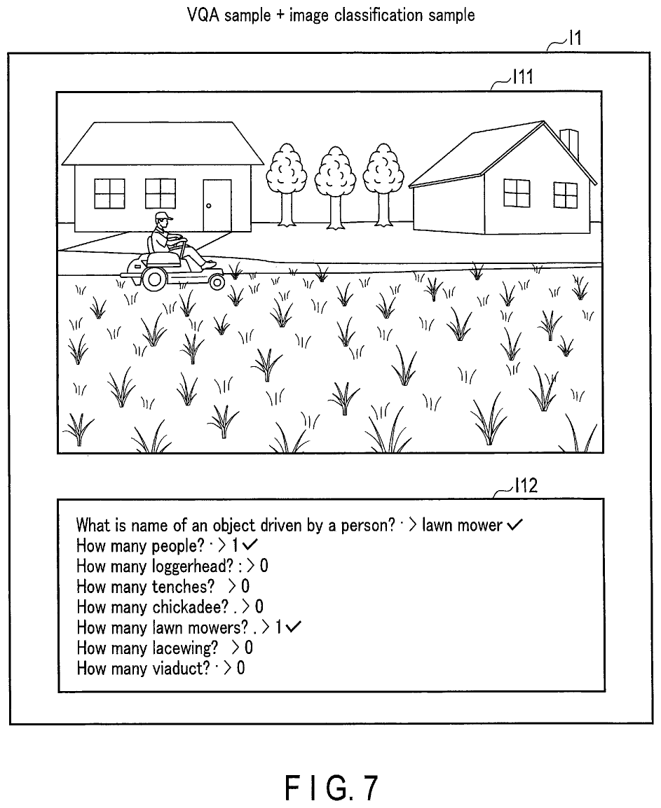

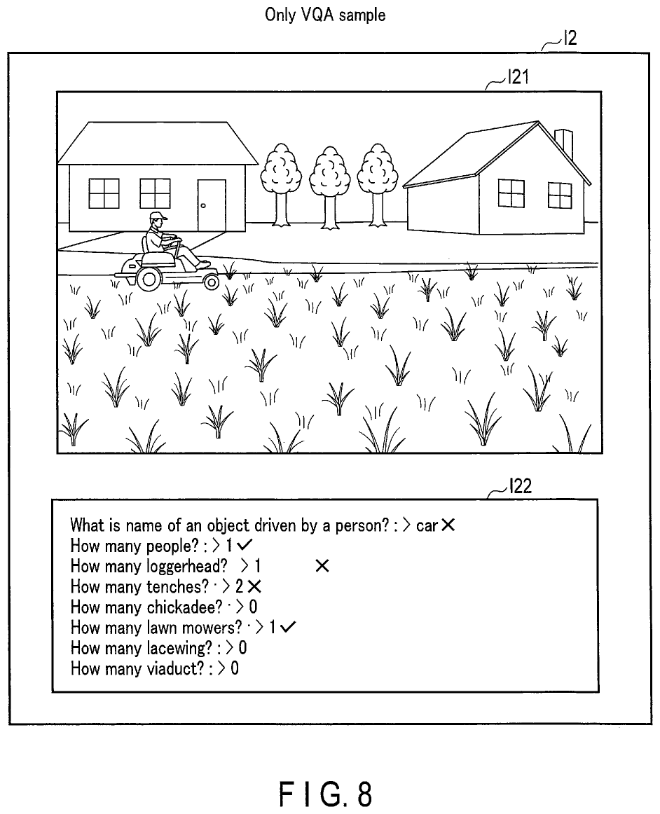

FIG. 7 is a view illustrating an example of a prediction result of a statistical model trained through machine learning according to the first embodiment. FIG. 8 is a view illustrating an example of a prediction result of a statistical model trained through machine learning according to the comparative example. In the machine learning according to the first embodiment, the statistical model is trained based on both the VQA sample and the image classification data. In the machine learning according to the comparative example, the statistical model is trained only using the VQA sample. It is assumed that a sample of a lawn mower is not included in the VQA sample and is included only in the image classification sample.

Display screens I1 and I2 indicating the prediction result are displayed at the display 15 by the display control unit 114. The display screens I1 and I2 include images I11 and I21 that are objects and display fields I12 and I22 of a question text and a predicted answer text. As illustrated in FIG. 8, in a case where learning is performed only using the VQA sample, there is an error in an answer in an item regarding a lawn mower, and erroneous answers are given to questions of other unknown words. In contrast, in the machine learning according to the present embodiment, learning is performed using the VQA sample and the image classification sample, and thus, a ground truth answer is obtained for an item regarding a lawn mower, and ground truth answers are given to questions of unknown words.

### Second Embodiment

In the second embodiment, machine learning of a statistical model of a VQA task using a VQA sample and an object detection sample will be described. The object detection sample is an example of a non-VQA sample. The same reference numerals will be assigned to components that are the same as the components in the first embodiment, and description will be omitted. Operational effects that are the same as the operational effects of the first embodiment will not be described unless necessary.

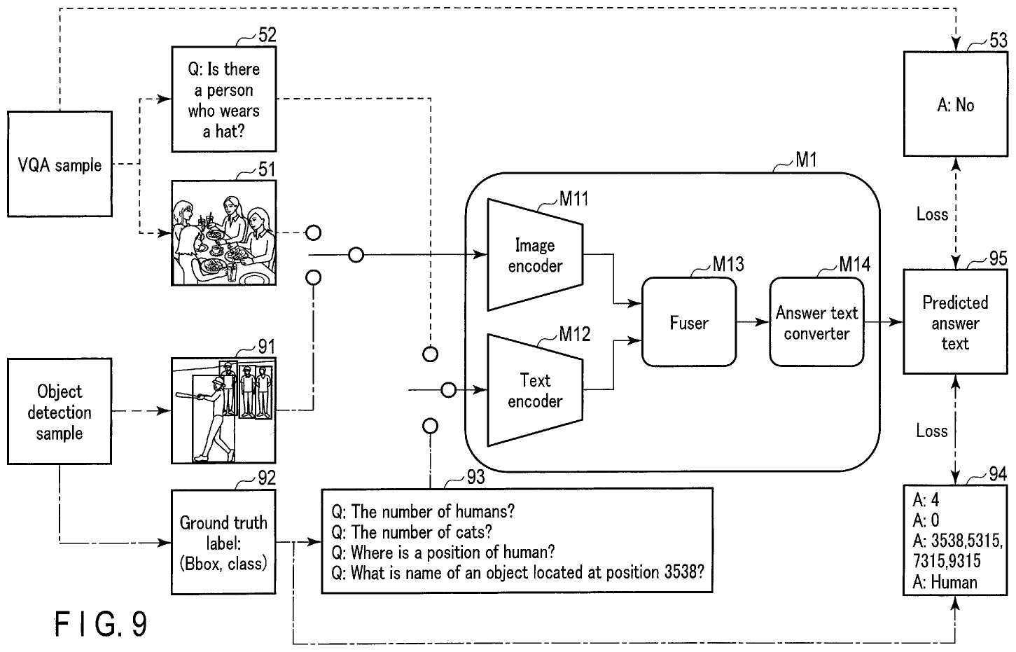

FIG. 9 is a view schematically illustrating machine learning processing for a statistical model M1 of the VQA task using the VQA sample and the object detection sample according to the second embodiment. As illustrated in FIG. 9, the object detection sample includes a combination of an image 91 and a ground truth label 92. The ground truth label 92 according to the object detection task is a rectangular (bounding box) ground truth parameter (Bbox) surrounding an object in the image 91 and a ground truth class (class) of the object.

The ground truth parameter includes a ground truth position and/or a ground truth size of the bounding box. The ground truth position is expressed with a position coordinate of the bounding box in the image 91. As an example, the position coordinate is expressed as a position of a unit image region obtained by normalizing a width and a height of the image 91 to a predetermined value (for example, 1) and dividing each of the width and the height equally into ten unit image regions. Note that the number of unit image regions obtained by equally dividing the width and the height is not limited to ten and may be any number such as 50 and 100. The position coordinate includes (left coordinate, top coordinate, right coordinate, bottom coordinate) of the bounding box as an element of the position coordinate. As an example, the ground truth size is expressed with (the number of unit image regions in a width direction, the number of unit image regions in a height direction). Such definition enables the ground truth position and the ground truth size to be expressed with character strings, for example, the position coordinate of “3538” and the size of “03”. This enables uniform training of the statistical model. Note that the left coordinate, the top coordinate, the right coordinate and the bottom coordinate may be respectively defined as combinations of a reference numeral representing a direction and a position of the unit image region like (L3T5R3B8). The ground truth class is a character string representing a class of the object in the image 91. In this manner, in the second embodiment, the ground truth label 92 is expressed with a character string also in the object detection sample.

As illustrated in FIG. 9, an additional sample including a question text 93 and a ground truth answer text 94 is generated by the conversion unit 112 based on the ground truth label 92 of the object detection sample. Specifically, the question text 93 and the ground truth answer text 94 regarding a position, a size and/or a class of the object in the image 91 are generated based on the ground truth parameter and the ground truth class of the bounding box that is the ground truth label 92. The question text 93 and the ground truth answer text 94 regarding the object detection task are classified into the following four types as an example. Note that a character string representing the ground truth class is inserted into “ground truth class”, a character string representing a class other than the ground truth class is inserted into “other than ground truth class”, a character string representing a ground truth position of the bounding box, that is, a ground truth position of the object is inserted into “position”, and a character string representing the number of ground truth positions of the bounding box, that is, the number of objects is inserted into “the number of positions”.

Type 1: Question text “The number of ‘ground truth class’?”, answer text “‘The number of ground truth positions’”
Type 2: Question text “The number of ‘other than ground truth class’?”, answer text “0”
Type 3: Question text “Where is position of ‘ground truth class’?”, answer text “‘ground truth position’”
Type 4: Question text “What is name of object located at ‘ground truth position’?”, answer text “‘ground truth class’”

As can be seen in Type 1 to Type 4, the question text 93 and the ground truth answer text 94 can be defined in accordance with simple rules based on the ground truth label 92. By using a template of each of Type 1 to Type 4, the question text 93 and the ground truth answer text 94 can be automatically generated. It is assumed in the example in FIG. 9 that the ground truth class is “human”, the number of ground truth positions is “4”, the ground truth positions are “3538”, “5315”, “7315” and “9315”. In this case, a question text of “The number of humans?” and a ground truth answer text of “4” are generated for Type 1, a question text of “The number of cats?” and a ground truth answer text of “0” are generated for Type 2, a question text of “Where is a position of human?” and a ground truth answer text of “3538, 5315, 7315, 9315” are generated for Type 3, and a question text of “What is name of an object located at position 3538?” and a ground truth answer text of “Human” are generated for Type 4. Note that combinations of the question text and the ground truth answer text are not limited to four types described above, and, for example, a question text and a ground truth answer text relating to the ground truth size may be generated.

According to the question text and the answer text of Type 1, it is possible to improve counting capabilities of objects by the statistical model M1. The question text and the answer text of Type 2 function as a negative sample. According to the question text and the answer text of Type 3, it is possible to improve recognition capabilities of a position of an object by the statistical model M1. According to the question text and the answer text of Type 4, it is possible to improve recognition capabilities of a class of an object by the statistical model M1.

According to the second embodiment, it is possible to easily generate character strings of question texts and ground truth answer texts regarding a class, a position and a size of an object from the ground truth label of the object detection sample. This makes it possible to cause the statistical model M1 to learn relationships between the question texts and the ground truth answer texts regarding the class, the position and the size of the object. Further, it is possible to ground the image, and the question text and the ground truth answer text. The image detection sample is converted into an additional sample in the VQA format and performs common machine learning processing of the statistical model using the additional sample and the image detection sample, so that it is possible to complete multitask learning of the VQA task and the image detection task by machine learning processing of one time. While the question text and the ground truth answer text are generated by utilizing the ground truth label included in the image detection sample, the question text and the ground truth answer text relate to content of the ground truth label of the image detection task as described in Type 1 to Type 4 described above. By performing machine learning processing of the statistical model using the additional sample, it is possible to train the statistical model capable of substantially performing the image detection task in a format of the VQA task.

### Third Embodiment

In the above-described first embodiment and second embodiment, machine learning of the statistical model of the VQA task utilizing the VQA sample and the non-VQA sample has been described. In a third embodiment, machine learning of a statistical model of a VQA task utilizing two types of non-VQA samples will be described. While the non-VQA tasks according to the third embodiment may be any of an image classification task, an object detection task, a visual grounding task and an image retrieval task, it is assumed as an example that the non-VQA tasks are the image classification task and the object detection task. It is assumed that in this case, the two types of non-VQA samples are the object detection sample and the image classification sample. The same reference numerals will be assigned to components that are the same as those in the first embodiment and the second embodiment, and description will be omitted. Operational effects that are the same as those in the first embodiment and the second embodiment will not be described unless necessary.

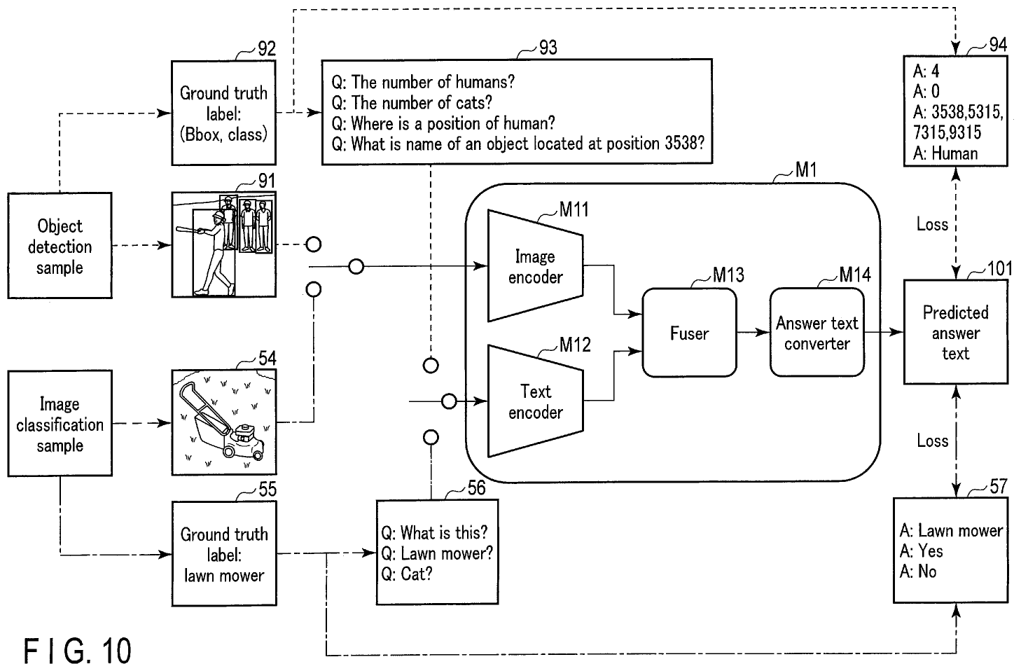

FIG. 10 is a view schematically illustrating machine learning processing for a statistical model M1 of the VQA task using the object detection sample and the image classification sample according to the third embodiment. As illustrated in FIG. 10, an additional sample including a question text 93 and a ground truth answer text 94 is generated based on a ground truth label 92 of the object detection sample in accordance with the method in the second embodiment, and an additional sample including a question text 56 and a ground truth answer text 57 is generated based on a ground truth label 55 of the image classification sample in accordance with the method in the first embodiment. The statistical model M1 of the VQA task is trained based on the additional sample generated based on the object detection sample and the additional sample generated based on the image classification sample. The statistical model M1 receives input of the additional sample generated based on the object detection sample or the additional sample generated based on the image classification sample and outputs a predicted answer text 101. According to the third embodiment, the statistical model M1 of the VQA task can be trained only based on samples of two different types of non-VQA tasks.

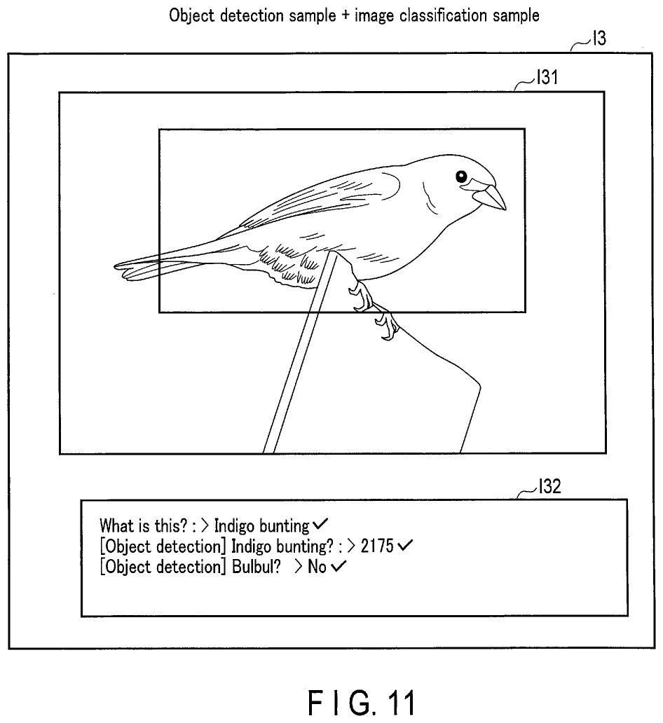

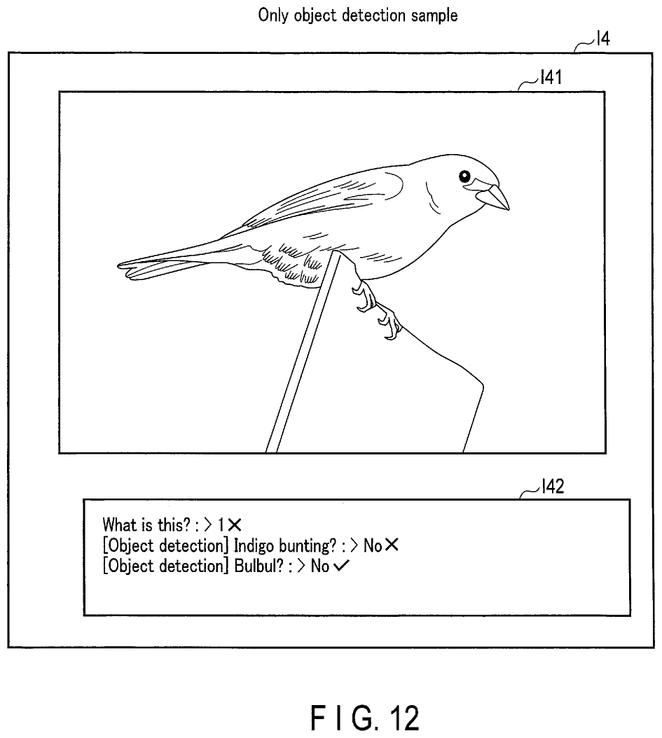

FIG. 11 is a view illustrating an example of a prediction result of the statistical model M1 trained through machine learning according to the third embodiment. FIG. 12 is a view illustrating an example of a prediction result of a statistical model M2 trained through machine learning according to the comparative example. In the machine learning according to the third embodiment, the statistical model is trained based on both the object detection sample and the image classification sample. In the machine learning according to the comparative example, the statistical model is trained only based on the object detection sample. A sample of a bird of a type called Indigo bunting is not included in the object detection sample and is included only in the image classification sample.

Display screens 13 and 14 representing prediction results are displayed on a display 15 by a display control unit 114. The display screens 13 and 14 include images 131 and 141 that are objects and display fields 132 and 142 of a question text and a predicted answer text. As illustrated in FIG. 12, the statistical model M2 trained only based on the object detection sample cannot detect a ground truth class of “Indigo bunting” that is not included in the object detection sample. As illustrated in FIG. 11, the statistical model M1 trained based on both the object detection sample and the image classification sample can detect a position coordinate of a ground truth class of “Indigo bunting” included in the image classification sample.

### Fourth Embodiment

In the first to the third embodiments, machine learning of the statistical model of the VQA task utilizing a sample having a format in accordance with some kind of task has been described. In a fourth embodiment, machine learning of a statistical model of a VQA task utilizing a sample (hereinafter, a non-task sample) having a format irrelevant to a task will be described. The non-task sample also includes an image and a label related to the image as elements. The label may be any character string regarding content of the image. It is assumed in the following description that the label is a caption for the image. A non-task sample including an image and a caption will be referred to as an image caption sample. Note that the same reference numerals will be assigned to components that are the same as those in the first to the third embodiments, and description will be omitted.

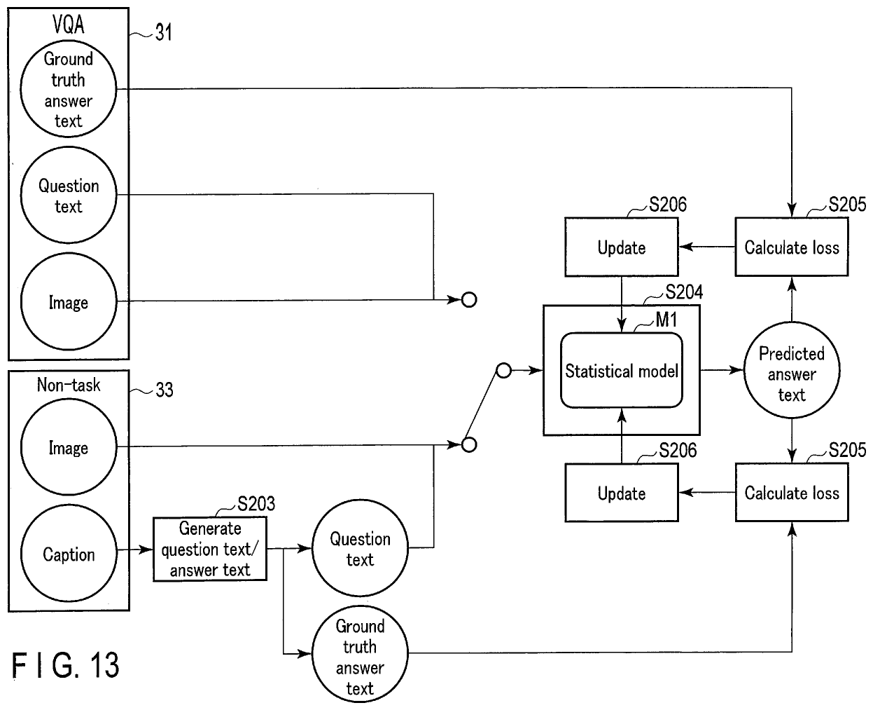

FIG. 13 is a view schematically illustrating machine learning processing according to the fourth embodiment. Machine learning according to the fourth embodiment is machine learning processing for a statistical model of a VQA task using a VQA sample 31 and an image caption sample 33 that is a non-task sample. As illustrated in FIG. 13, the image caption sample 33 includes a combination of an image and a caption. For example, the caption of the image illustrated in FIG. 11 and FIG. 12 is “Indigo bunting lands on a signboard”.

As illustrated in FIG. 13, a question text and a ground truth answer text are generated by a conversion unit 112 based on the caption. It is known that a task (mask language modeling) that, when an image and a caption are provided, predicts a masked word from the caption, part of which is masked, is effective (Li, Liunian Harold and Yatskar, Mark and Yin, Da and Hsieh, Cho-Jui and Chang, Kai-Wei, “Visualbert: A simple and performant baseline for vision and language”, arXiv preprint arXiv:1908.03557, 2019).

The conversion unit 112 randomly selects part of words among a plurality of words constituting the caption and masks the word. A word to be masked may have any word class, but is preferably selected from proper nouns and verbs that can be easily drawn on an image. The caption after masking is set as a question text, and the masked word is set as a ground truth answer text. A specific example where the original caption is “a man is walking along a white house” will be described. In this case, as an example, a question text is “[masked] A man is walking along a white *”, and a ground truth answer text is “house”. [mask] in the question text is an indicator indicating a mask language modeling task, and * indicates a mask. By generating a question text and a ground truth answer text from a caption in accordance with such rules, a mask language modeling task can be trained at the same time as the VQA task without a sample and a head being switched.

### First Modification

In the above-described embodiments, a modality of an object included in various kinds of samples is an image. However, a modality of an object of the present embodiment is not limited to this, and the present embodiment can be also applied to a video, audio, a sensor output and/or a three-dimensional point cloud. The video means time-series image data collected by a video camera, or the like. The audio means time-series audio data collected by a microphone, or the like. The sensor output means time-series data of measurement values output from various kinds of sensor. The sensor corresponds to, for example, a manometer, a thermometer, a volmeter, an ammeter, or the like, attached to various kinds of devices constituting a generator. The three-dimensional point cloud means three-dimensional data of a plurality of sample points on an object by light detection and ranging (LIDAR), or the like.

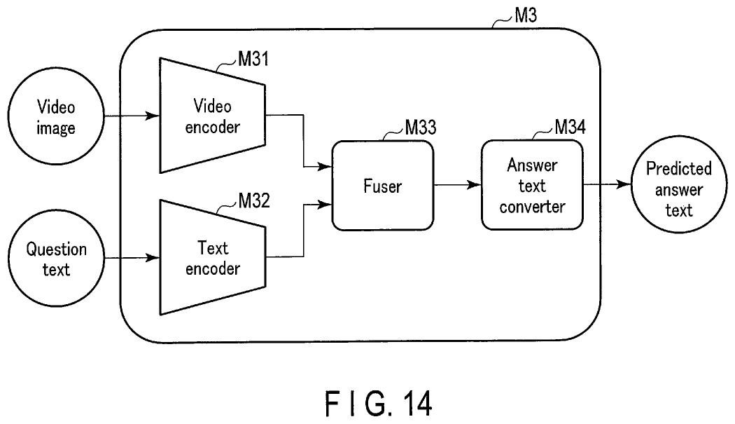

FIG. 14 is a view illustrating a network configuration example of a statistical model M3 in a case where a modality of an object is a video. The statistical model M3 includes a video encoder M31, a text encoder M32, a fuser M33 and an answer text converter M34. The video encoder M31 is an encoding network layer that outputs a feature (hereinafter, a video feature) of the input video. The text encoder M32 is an encoding network layer that outputs a text feature of the input question text. The fuser M33 outputs a fused feature of the video feature output from the video encoder M31 and the text feature output from the text encoder M32. The fuser M33 may be a module that performs addition calculation or concatenation or an encoding network layer. The answer text converter M34 is a decoding network layer that converts the fused feature output from the fuser M33 into a language sequence of natural language that represents an answer text.

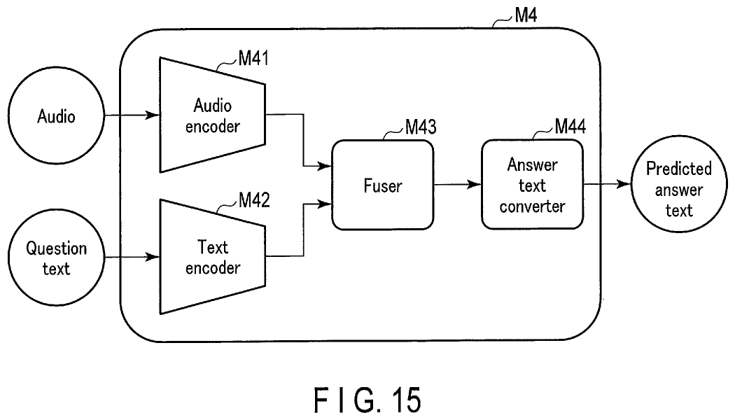

FIG. 15 is a view illustrating a network configuration example of a statistical model M4 in a case where a modality of an object is audio. The statistical model M4 includes a audio encoder M41, a text encoder M42, a fuser M43 and an answer text converter M44. The audio encoder M41 is an encoding network layer that outputs a feature (hereinafter, a audio feature) of the input audio. The text encoder M42 is an encoding network layer that outputs a text feature of the input question text. The fuser M43 outputs a fused feature of the audio feature output from the audio encoder M41 and the text feature output from the text encoder M42. The fuser M43 may be a module that performs addition calculation or concatenation or may be an encoding network layer. The answer text converter M44 is a decoding network layer that converts the fused feature output from the fuser M43 into a language sequence of natural language representing an answer text.

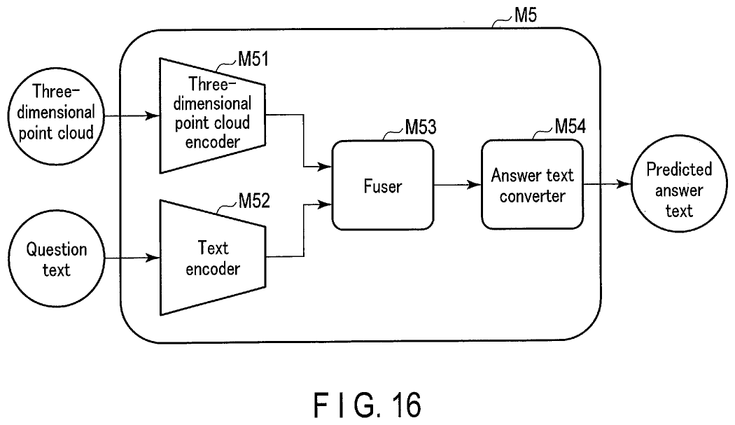

FIG. 16 is a view illustrating a network configuration example of a statistical model M5 in a case where a modality of an object is a three-dimensional point cloud. The statistical model M5 includes a three-dimensional point cloud encoder M51, a text encoder M52, a fuser M53 and an answer text converter M54. The three-dimensional point cloud encoder M51 is an encoding network layer that outputs a feature (hereinafter, a three-dimensional point cloud feature) of the input three-dimensional point cloud. The text encoder M52 is an encoding network layer that outputs a text feature of the input question text. The fuser M53 outputs a fused feature of the three-dimensional point cloud feature output from the three-dimensional point cloud encoder M51 and the text feature output from the text encoder M52. The fuser M53 may be a module that performs addition calculation or concatenation or may be an encoding network layer. The answer text converter M54 is a decoding network layer that converts the fused feature output from the fuser M53 into a language sequence of natural language representing an answer text.

In this manner, the statistical model according to the present embodiment can support a variety of modalities. Note that in a case of time-series data such as a video, audio and a sensor output, a question text and a ground truth answer text regarding a time axis can be generated. For example, in a case of a video of a security camera, a question text of “Period during which there is a masked man?” and a ground truth answer text of “14:03-14:14” may be generated. For example, a time stamp associated with each frame can be used as time.

### Second Modification

Further, it has been assumed in the above-described embodiments that language to be used in the question text, the answer text, and the like, in the VQA task is English. However, there is no restriction in a type of language according to the present embodiment, and the language may be Japanese, Chinese, Korean, German, Dutch, Portuguese, Spanish, French, or the like.

### Inference Apparatus

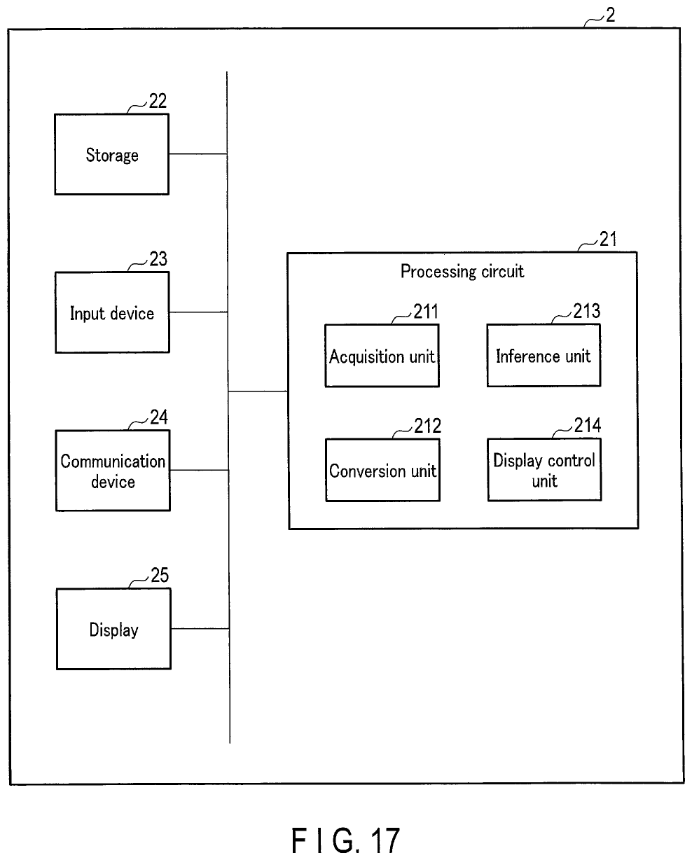

FIG. 17 is a view illustrating a configuration example of an inference apparatus 2 according to the present embodiment. As illustrated in FIG. 17, the inference apparatus 2 is a computer including a processing circuit 21, a storage 22, an input device 23, a communication device 24 and a display 25. The processing circuit 21, the storage 22, the input device 23, the communication device 24 and the display 25 perform data communication with each other via a bus.

The processing circuit 21 includes a processor such as a CPU and a memory such as a RAM. The processing circuit 21 includes an acquisition unit 211, a conversion unit 212, an inference unit 213 and a display control unit 214. The processing circuit 21 implements respective functions of the above-described units 211 to 214 by executing an inference program. The inference program is stored in a non-transitory computer readable recording medium such as the storage 22. The inference program may be implemented as a single program that describes all the functions of the above-described units 211 to 214 or may be implemented as a plurality of modules divided into some functional units. Further, the above-described units 211 to 214 may be implemented by an integrated circuit such as an application specific integrated circuit and an FPGA. In this case, the above-described units 211 to 214 may be implemented in a single integrated circuit or may be individually implemented in a plurality of integrated circuits.

The acquisition unit 211 acquires an object to be processed. The object to be processed means an object to be provided for inference processing by the statistical model of the VQA task trained in accordance with the above-described various embodiments. While the object is typically an image or a video, the object is not limited to this, and data obtained by various kinds of modalities, such as audio, a sensor output and/or a three-dimensional point cloud may be used. For the object to be processed, a corresponding question text may be generated or does not have to be generated. In a case where a corresponding question text is generated, the question text is associated with the object to be processed.

The conversion unit 212 generates a question text regarding the object to be processed in a case where a question text is not generated for the object to be processed. In other words, the conversion unit 212 converts the object into a format for inference of the VQA task.

The inference unit 213 infers an answer text in response to the question text by applying the object and the question text regarding the object to the statistical model of the VQA task.

The display control unit 214 displays various kinds of information on the display 25. For example, the display control unit 214 displays an inference result, and the like, of the VQA task obtained by the inference unit 213.

The storage 22 is constituted with a ROM, an HDD, an SSD, an integrated circuit storage device, or the like. The storage 22 stores the inference program, the statistical model of the VQA task, and the like.

The input device 23 inputs various kinds of commands from an operator. As the input device 23, a keyboard, a mouse, various kinds of switches, a touch pad, a touch panel display, or the like, can be utilized. An output signal from the input device 23 is supplied to the processing circuit 21. Note that an input device of a computer connected to the processing circuit 21 in a wired or wireless manner may be used as the input device 23.

The communication device 24 is an interface for performing data communication with an external device connected to the inference apparatus 2 via a network. The communication device 24 is a computer that stores objects to be processed, various kinds of collection apparatuses that collect objects.

The display 25 displays various kinds of information under control by the display control unit 214. As the display 25, a CRT display, a liquid crystal display, an organic EL display, an LED display, a plasma display or other arbitrary displays known in the technical field can be utilized as appropriate. Further, the display 25 may be a projector.

The inference apparatus 2 will be described in detail below. It is assumed in the following description that the object is an image.

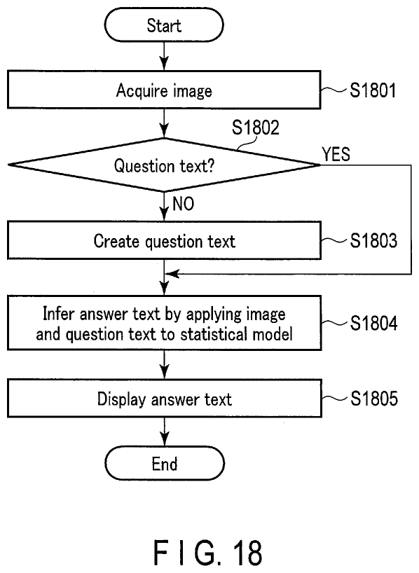

FIG. 18 is a view illustrating processing procedure of inference processing by the inference apparatus 2. As illustrated in FIG. 18, the acquisition unit 211 acquires an image to be processed (step S1801). A question text may be generated or does not have to be generated for the image to be processed.

If the processing in step S1801 is performed, the conversion unit 212 determines whether or not there is a question text for the image acquired in step S1801 (step S1802). As an example, the conversion unit 212 only requires to determine that there is a question text in a case where a question text is associated with the image to be processed, and determine that there is no question text in a case where a question text is not associated with the image to be processed. Note that the operator may input whether or not there is a question text via the input device 23.

In a case where it is determined in step S1802 that there is no question text (step S1802: No), the conversion unit 212 generates a question text for the image acquired in step S1801 (step S1803). As an example, the conversion unit 212 generates a fixed question text. As the fixed question text, a versatile question text that does not depend on content of the image to be processed is preferably used. For example, “What is this?” is appropriate as the fixed question text.

As another example, the conversion unit 212 may generate a question text based on a label associated with the image. Further, in a case where an image of a VQA sample or a non-VQA sample is used as the image to be processed, the conversion unit 212 may generate a question text based on a ground truth label included in the VQA sample or the non-VQA sample in a similar manner to the conversion unit 112.

In a case where the processing in step S1803 is performed or in a case where it is determined in step S1802 that there is a question text (step S1802: Yes), the inference unit 213 infers an answer text by applying the image and the question text to the statistical model of the VQA task (step S1804). More specifically, the inference unit 213 calculates a plurality of logit series respectively corresponding to a plurality of words constituting an inferred answer text by applying the image and the question text to the statistical model. Then, the inference unit 213 specifies a registered word ID having a maximum logit from each of the plurality of logit series and applies the specified registered word IDs to a tokenizer dictionary to convert the specified registered word IDs into language sequences of the registered words. The answer text converter M14 predicts a character string representing the inferred answer text by converting all the logit series into language sequences of registered words and coupling the language sequences.

In a case where the processing in step S1804 is performed, the display control unit 214 displays the inferred answer text obtained in step S1804 at the display (step S1805). The display control unit 214 may display the image, the question text and the inferred answer text in one screen as an example instead of displaying only the inferred answer text.

As described above, the inference processing by the inference apparatus 2 ends. The statistical model according to the present embodiment can perform training by utilizing the additional sample obtained by converting the non-VQA sample into the VQA format, so that training can be performed based on a large number of samples, which can improve inference accuracy. Further, a question text can be automatically generated, so that it is possible to reduce load of generation of a question text.

Note that the inference processing illustrated in FIG. 18 is an example, and the inference processing according to the present embodiment is not limited to this. The statistical model according to the present embodiment can process an image classification task, an object detection task, a visual grounding task, an image retrieval task, and the like, in a format of the VQA task as described in the above embodiments. Thus, as a fixed question text, a question text regarding content in accordance with these tasks may be prepared. In this event, generation of a question text and inference of an answer text may be circularly performed so that a question text is generated again from an inferred answer text in response to a basic question text of “What is this?”. For example, if an image of “lawn mower” and a question text of “What is this?” are applied to the statistical model, an inferred answer text of “lawn mower” is output. An answer text in accordance with the object detection task, the visual grounding task or the image retrieval task is generated based on the inferred answer text of “lawn mower”. For example, “Where is a position of a lawn mower?” is appropriate as a fixed question text belonging to the object detection task. “What is under a lawn mower?” is appropriate as a fixed question text belonging to the visual grounding task. By circularly performing generation of a question text and inference of an answer text in this manner, the statistical model can answer a question in accordance with the trained various kinds of tasks. A type of a fixed question text may be arbitrarily selected by the operator via the input device 23 or may be exhaustively selected.

As described above, according to the present embodiment, it is possible to provide a machine learning apparatus capable of learning a statistical model of a VQA task with high efficiency, a machine learning method, and an inference apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning apparatus comprising:
a processing circuit that generates a training sample in a visual question answering (VQA) format regarding a VQA task based on a sample in a non-VQA format, the training sample in the VQA format including a combination of an object, a question text regarding the object and an answer text in response to the question text as elements, the sample in the non-VQA format including a combination of an object and a label related to the object as elements, and
trains a statistical model of the VQA task based on the generated training sample in the VQA format.

2. The machine learning apparatus according to claim 1,
wherein the processing circuit generates the question text and the answer text based on the label.

3. The machine learning apparatus according to claim 2,
wherein the sample is a training sample obtained from a training sample for a non-VQA task different from the VQA task and including a ground truth label for the object in accordance with the non-VQA task as the label, and
the processing circuit generates the question text and the answer text based on the ground truth label.

4. The machine learning apparatus according to claim 3,
wherein the non-VQA task is an image classification task, an object detection task, a visual grounding task or an image retrieval task.

5. The machine learning apparatus according to claim 1,
wherein the processing circuit trains the statistical model based on the training sample and the training sample.

6. The machine learning apparatus according to claim 1,
wherein the sample includes a caption for the object as the label, and
the processing circuit generates the question text and the answer text based on the caption.

7. The machine learning apparatus according to claim 1,
wherein the statistical model comprises:
an encoder that converts the object into a first feature;
an encoder that converts the answer text into a second feature;
a fuser that generates a fused feature of the first feature and the second feature; and
a converter that converts the fused feature into a character string of natural language representing the answer text.

8. The machine learning apparatus according to claim 7,
wherein the converter converts the fused feature into a relative value series representing occurrence probabilities of words constituting the answer text.

9. The machine learning apparatus according to claim 1,
wherein the object is an image, a video, audio, a sensor output and/or a three-dimensional point cloud.

10. A machine learning method comprising:
a conversion step of generating a training sample in a visual question answering (VQA) format regarding a VQA task based on a sample in a non-VQA format, the training sample in the VQA format including a combination of an object, a question text regarding the object and an answer text in response to the question text as elements, and the sample in the non-VQA format including a combination of an object and a label related to the object as elements; and
a training step of training a statistical model of the VQA task based on the training sample in the VQA format generated in the conversion step.

11. An inference apparatus comprising:
a processing circuit that applies an object and a question text regarding the object to a statistical model of a visual question answering (VQA) task according to claim 1 to infer an answer text in response to the question text, and
displays the answer text at a display.

12. The inference apparatus according to claim 11,
wherein the processing circuit generates the question text based on a label associated with the object.

13. The inference apparatus according to claim 11,
wherein the processing circuit generates the question text that is fixed.
